(19) United States
(12) Patent Application Publication
(10) Pub. No.: US 2021/0399379 A1
(43) Pub. Date: Dec. 23, 2021

(54) DISPOSABLE VEHICLE STARTER AND METHOD

(71) Applicant: James Wurth, Las Vegas, NV (US)

(72) Inventor: James Wurth, Las Vegas, NV (US)

(21) Appl. No.: 17/193,857

(22) Filed: Mar. 5, 2021

Related U.S. Application Data
(60) Provisional application No. 62/986,455, filed on Mar. 6, 2020.

(51) Int. Cl. H01M 50/247; H01R 13/04; H01M 50/256; H01M 6/50; H01M 50/296

(52) U.S. Cl. CPC H01M 50/247; H01R 13/04; H01M 50/256; B60L 2200/10; H01M 50/296; H01R 2201/26; H01M 2220/30; H01M 6/505

(57) ABSTRACT

A disposable portable vehicle starting unit including a housing having a handle for carrying the disposable portable vehicle starting unit by hand or by attaching to clothing, a lithium ion 28 volt battery enclosed in the housing, and a 3-pin connector attached to the housing and electrically connected to positive and negative terminals of the lithium ion 28 volt battery, the 3-pin connector being externally accessible.

### CROSS-REFERENCE TO RELATED APPLICATION

This application claims the benefit of U.S. Provisional Patent Application No. 62/986,455, filed 6 Mar. 2020.

### FIELD OF THE INVENTION

This invention relates to a portable vehicle starting unit and more specifically to a vehicle starting unit that is light and cheap, and disposable after a single use.

### BACKGROUND OF THE INVENTION

In the military it is often necessary to have the means to start an electrical start vehicle, such as a truck, tank, airplane, helicopter, or the like that has a dead or near dead battery, at a moment's notice. Often there will not be time to bring in a large permanent charging or starter unit. In such instances, a military person may have only moments to start the vehicle and leave. Further, in such instances, once the vehicle is started the military person will not have time to return a large charging or starting unit to its normal storage space.

It would be highly advantageous, therefore, to remedy this and other deficiencies inherent in the prior art.

Accordingly, it is an object of the present invention to provide a new and improved disposable portable vehicle starting unit.

It is another object of the present invention to provide a new and improved disposable portable vehicle starting unit that is light enough for a military person to carry conveniently under normal circumstances.

It is another object of the present invention to provide a new and improved disposable portable vehicle starting unit that is light enough for a military person to carry conveniently for a lengthy period of time (e.g. hours to days).

### SUMMARY OF THE INVENTION

Briefly to achieve the desired objects and advantages of the present invention a disposable portable vehicle starting unit is provided including a housing having a handle for carrying the disposable portable vehicle starting unit by hand or by attaching to clothing, a lithium ion 28 volt battery enclosed in the housing, and a 3-pin connector attached to the housing and electrically connected to positive and negative terminals of the lithium ion 28 volt battery, the 3-pin connector being externally accessible.

To further achieve the desired objects and advantages of the present invention a specific embodiment of a disposable portable vehicle starting unit is provided. The unit includes a housing, the housing having a handle for carrying the disposable portable vehicle starting unit by hand or by attaching to clothing. A lithium ion 28 volt battery is enclosed in the housing, the lithium ion 28 volt battery having positive and negative terminals. A volt meter is mounted in the housing and viewable externally, the volt meter being electrically attached to the positive and negative terminals of the lithium ion 28 volt battery. A 3-pin connector is attached to the housing and electrically connected to the positive and negative terminals of the lithium ion 28 volt battery. The 3-pin connector is designed to mate with starting electrical connectors in aviation vehicles and externally accessible. The disposable portable vehicle starting unit weighing 6 pounds, plus or minus one pound.

To further achieve the desired objects and advantages of the present invention a specific method of starting an electrical start vehicle includes the step of providing a disposable portable vehicle starting unit including a housing, a lithium ion 28 volt battery enclosed in the housing, and a 3-pin connector attached to the housing and electrically connected to the lithium ion 28 volt battery, the disposable portable vehicle starting unit weighing 6 pounds, plus or minus one pound. The method further includes the steps of the disposable portable vehicle starting unit being carried by a military person for a period of hours to days, the military person attaching the 3-pin connector to an electrical starting connector of one of an electric start aviation vehicle or an electric start ground vehicle, starting the electric start aviation vehicle or electric start ground vehicle, and disconnecting and disposing of the disposable portable vehicle starting unit.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is a side perspective view of a disposable vehicle starting unit, in accordance with the present invention;

FIG. 2 is a schematic diagram for the disposable vehicle starting unit of FIG. 1; and

FIG. 3 is a perspective view of an adapter attachable to the disposable vehicle starting unit for use on vehicles.

### DETAILED DESCRIPTION OF THE DRAWINGS

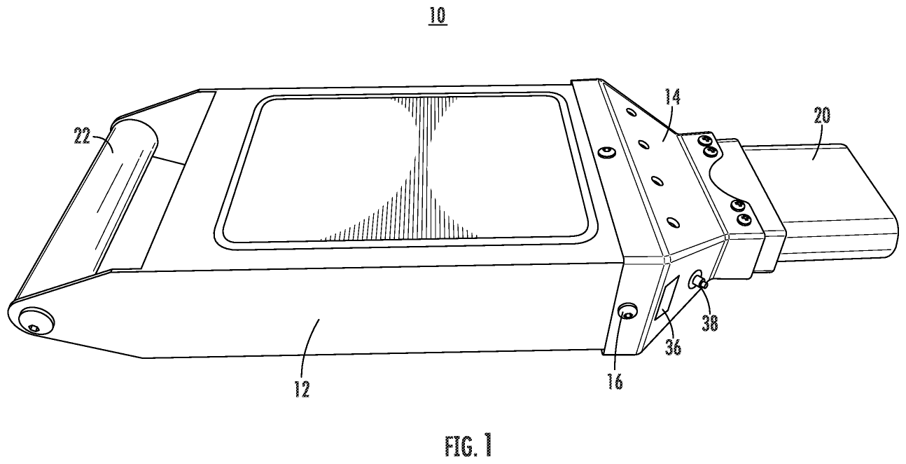

Turning to the drawings and specifically to FIG. 1, a disposable portable vehicle starting unit 10 is illustrated, in accordance with the present invention. A main purpose of disposable portable vehicle starting unit 10 is for the military in critical situations where weight is very important. Disposable portable vehicle starting unit 10 includes a housing 12 with a removable end 14 (discussed in more detail below) sealingly engaged to housing 12 by fasteners such as clamps or screws 16. End 14 also includes a 3-pin connector 20 that is designed specifically to mate with starting electrical connectors in aviation vehicles.

Housing 12 also has attached thereto a handle 22 specially designed to be used by military personnel, such as special forces, to conveniently carry disposable vehicle starting unit 10. Handle 22 is designed so that starting unit 10 can be conveniently attached to clothing and the like using belts, ropes, etc. and the military personnel carrying starting unit 10 will have hands free and only a light drag on clothing,

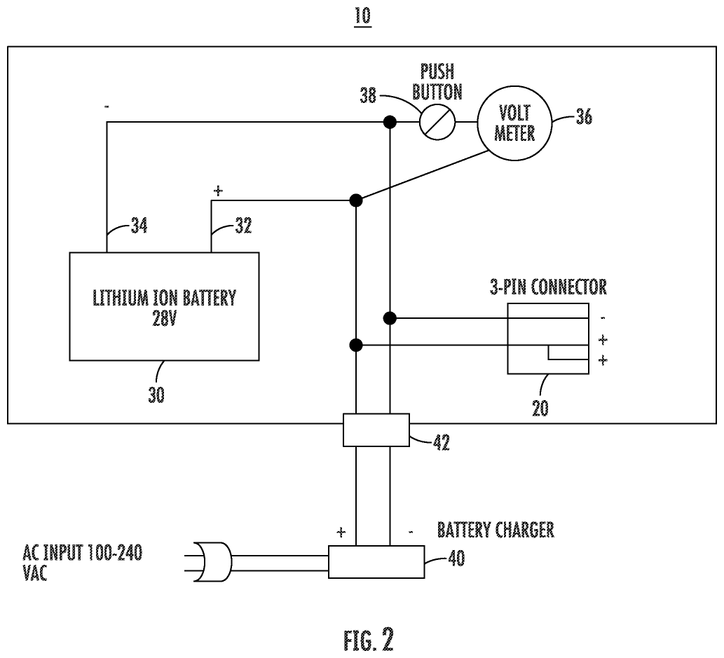

Turning to FIG. 2, a schematic diagram of disposable portable vehicle starting unit 10 is illustrated. The positive terminal 32 of a battery, preferably a lithium ion battery 30 is electrically connected to the positive terminal of 3-pin connector 20 and the negative terminal 34 of lithium ion battery 30 is electrically connected to the negative terminal of 3-pin connector 20. The third pin of 3-pin connector 20 is also connected to the positive terminal of 3-pin connector 20. One input terminal of a volt meter 36 is connected to positive terminal 32 of lithium ion battery 30 and the other input terminal of volt meter 36 is connected through a push button switch 38 to negative terminal 34 of lithium ion battery 30.

Lithium ion battery 30 is a 28 volt battery with enough power/electrical current to start any electrically started 24 volt engines in aviation vehicles or ground vehicles such as trucks, tanks, etc. Disposable portable vehicle starting unit 10 only weighs approximately 6 pounds and is convenient to carry. It will be understood that the weight of disposable portable vehicle starting unit 10 can vary a small amount, for example up to a pound more or less. Disposable portable vehicle starting unit 10 is easy to carry and is convenient to use and is primarily for use by military personnel, e.g. Special Forces, in critical situations in which an electric start vehicle must be started quickly.

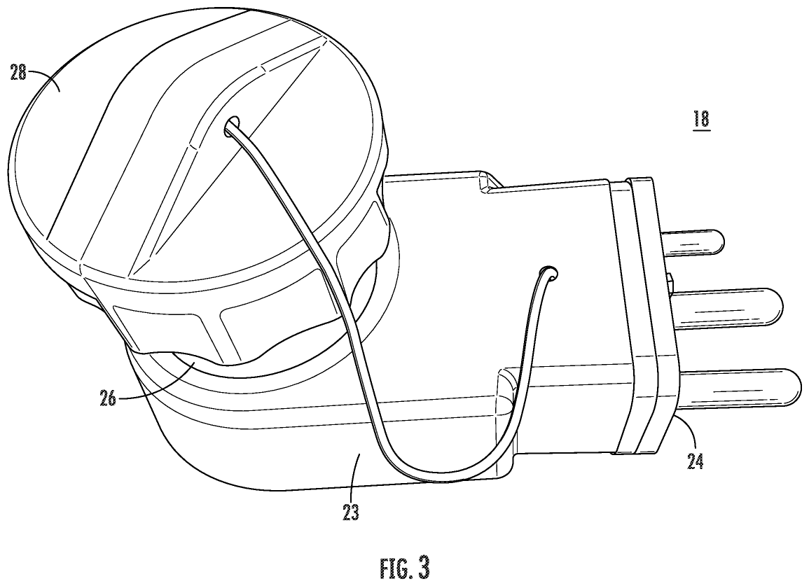

An adapter 18 as illustrated in FIG. 3 can be attached for use with electrical start ground vehicles, such as trucks, tanks, or virtually any other military vehicle. In this specific embodiment, adapter 18 is designed with a body 23 including a 3-prong electrical connector 24 designed to mate with 3-pin connector 20 of removable end 14 extending outwardly from one end. An electrical connector 26, designed to mate with the electrical starting connector of an electric start ground vehicle, extends upwardly at a ninety degree angle from body 23. Electrical connector 26 is not visible because it is covered with a protective cap 28 during normal storage conditions. As will be understood, 3-prong electrical connector 24 when engaged with 3-pin connector 20 electrically connects electrical connector 26 to the terminals of lithium ion battery 30.

In operation, disposable vehicle starting unit 10 is assembled in the factory and is charged by means of an external battery charger 40 connected to battery 30 through an internal connector 42 (see FIG. 2). In the specific embodiment illustrated, battery charger 40 is a converter that converts AC input from a plug into a DC charging voltage. Once battery 30 is charged and end 14 is sealed to housing 12, it cannot be charged again. Therefore, after assembly, disposable vehicle starting unit 10 is shipped to the customer charged to a storage level (such as 30% charge). Disposable vehicle starting unit 10 can be stored with the battery at a storage level for an extended period of time, while a fully charged battery has a limited life. When disposable vehicle starting unit 10 is distributed for use, such as being carried on a mission, battery 30 is given its full charge using the separate charger, and as stated previously can then not be charged again. When an electrical charge is needed, 3-pin connector 20 is inserted into (or attached to) the electrical starting connector of an electric start vehicle to be started. Button 38 can be depressed to check the starting voltage available at the vehicle. Once the vehicle starts, disposable vehicle starting unit 10 can be disposed of in any convenient way under the circumstances.

In a typical situation requiring a vehicle starting unit, a Special Forces person in a combat environment arrives at a vehicle (e.g. a truck) that is needed to move forward but the truck has a dead battery. The Special Forces person quickly attaches an adapter 18 to a starting electrical connector of the truck and disengages disposable vehicle starting unit 10 from any clothing to which it may be attached. The 3-pin connector 20 of disposable vehicle starting unit 10 is inserted into adapter 18 and the truck is quickly started. Adapter 18 and disposable vehicle starting unit 10 are disengaged and disposed of, for example by placing them in the back of the truck. The Special Forces person can then quickly continue on the way after only a few moments of delay.

Thus, a new and improved disposable vehicle starting unit is provided. The unit is light enough to conveniently carry (approximately 6 pounds) and is designed to start any electrically started 24 volt engines either in aviation or trucks, tanks, or other vehicles. The unit is not rechargeable, since it would be very inconvenient to carry around until a charger could be found, and thus once used is immediately disposed of in the most convenient fashion under the circumstances.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A disposable portable vehicle starting unit comprising;
a housing, the housing having a handle for carrying the disposable portable vehicle starting unit by hand or by attaching to clothing;
a 28 volt battery enclosed in the housing, the 28 volt battery having positive and negative terminals; and
a 3-pin connector attached to the housing and electrically connected to the positive and negative terminals of the 28 volt battery, the 3-pin connector being externally accessible.

2. The disposable portable vehicle starting unit as claimed in claim 1 wherein the disposable portable vehicle starting unit weighs 6 pounds, plus or minus one pound.

3. The disposable portable vehicle starting unit as claimed in claim 1 further including a volt meter mounted in the housing and viewable externally, the volt meter being electrically attached to the positive and negative terminals of the 28 volt battery.

4. The disposable portable vehicle starting unit as claimed in claim 1 wherein the 3-pin connector is designed to mate with starting electrical connectors in aviation vehicles.

5. The disposable portable vehicle starting unit as claimed in claim 4 further including an adapter designed to mate with the 3-pin connector and to couple the 3-pin connector to an electrical starting connector of an electric start ground vehicle.

6. A disposable portable vehicle starting unit comprising;
a housing, the housing having a handle for carrying the disposable portable vehicle starting unit by hand or by attaching to clothing;
a lithium ion 28 volt battery enclosed in the housing, the lithium ion 28 volt battery having positive and negative terminals;
a volt meter mounted in the housing and viewable externally, the volt meter being electrically attached to the positive and negative terminals of the lithium ion 28 volt battery;
a 3-pin connector attached to the housing and electrically connected to the positive and negative terminals of the lithium ion 28 volt battery, the 3-pin connector being designed to mate with starting electrical connectors in aviation vehicles and externally accessible; and
the disposable portable vehicle starting unit weighing 6 pounds, plus or minus one pound.

7. The disposable portable vehicle starting unit as claimed in claim 6 further including an adapter designed to mate with the 3-pin connector and to couple the 3-pin connector to an electrical starting connector of an electric start ground vehicle.

8. A method of starting an electrical start vehicle comprising the steps of;
providing a disposable portable vehicle starting unit including a housing, a lithium ion 28 volt battery enclosed in the housing, and a 3-pin connector attached to the housing and electrically connected to the lithium ion 28 volt battery, the disposable portable vehicle starting unit weighing 6 pounds, plus or minus one pound;
the disposable portable vehicle starting unit being carried by a military person for a period of hours to days;
the military person attaching the 3-pin connector to an electrical starting connector of one of an electric start aviation vehicle or an electric start ground vehicle;
starting the electric start aviation vehicle or electric start ground vehicle; and
disconnecting and disposing of the disposable portable vehicle starting unit.

9. A method of starting an electrical start vehicle as claimed in claim 8 wherein the 3-pin connector of the disposable portable vehicle starting unit is designed to mate with starting electrical connectors in aviation vehicles.

10. A method of starting an electrical start vehicle as claimed in claim 8 further including a step of providing an adapter designed to electrically connect the disposable portable vehicle starting unit to an electric start ground vehicle.
